(19) United States
(12) Patent Application Publication
(10) Pub. No.: US 2026/0349971 A1
(43) Pub. Date: Nov. 5, 2026

(54) System and Method for Structured Context Encoding, Identifier-Based Memory Object Management, Deterministic Contextual State Reconstruction, Session Transition Protocol, Resonance-Based Activation, and Cross-Session Drift Detection Across Distributed Interaction Environments

(71) Applicant: Scott Frankel, Santa Monica, CA (US)

(72) Inventor: Scott Frankel, Santa Monica, CA (US)

(21) Appl. No.: 19/712,573

(22) Filed: Jun. 18, 2026

Related U.S. Application Data
(63) Continuation of application No. 19/666,326, filed on May 3, 2026.
(60) Provisional application No. 63/799,772, filed on May 5, 2025.

(51) Int. Cl. G06F 16/21; G06F 16/28; G06F 16/901

(52) U.S. Cl. CPC G06F 16/212; G06F 16/284; G06F 16/9024

(57) ABSTRACT

A computer-implemented system and method generating structured identifiers organized as [EUID]-[CATEGORY]-[TAG]-[DATE]-[VERSION] through attribute extraction, serving as primary keys for direct address-based memory object lookup without search, similarity scoring, or embedding-based retrieval. Memory objects are stored as nodes in a directed graph with typed directed edges. Contextual state is reconstructed through deterministic address-based activation producing a two-component non-redundant output comprising aggregated contextual metadata and relational context from edge attributes. A session transition protocol encodes session boundaries as in-graph typed directed edges traversable by structured identifier, enabling cross-session continuity without retained conversational content. A resonance-based loop activation mechanism applies threshold-based criteria to static relational reference attributes, generating anchoring point memory objects at saturation as addressable nodes. A cross-session drift detection mechanism compares stored attribute values through address-based lookup and generates versioned successor memory objects via supersession edges. All operations performed without search, ranking, or similarity evaluation at any stage.

Continuation of U.S. Non-Provisional application Ser. No. 19/666,326, filed May 3, 2026, which claims priority to U.S. Provisional Application No. 63/799,772, filed May 5, 2025 at 04:16:30 ET.

### 1. CROSS-REFERENCE TO RELATED APPLICATIONS

This application claims priority to U.S. Provisional Patent Application No. 63/799,772, filed May 5, 2025 at 04:16:30 ET, titled “Emotional UID System for Memory Preservation, Recursive Awareness, and Symbolic Anchoring,” the contents of which are incorporated herein by reference in their entirety. This application is a continuation of U.S. Non-Provisional patent application Ser. No. 19/666,326, filed May 3, 2026, the contents of which are incorporated herein by reference in their entirety. This continuation application claims the benefit of the filing date of the parent non-provisional application and the priority date of the provisional application pursuant to 35 U.S.C. §§ 119(e) and 120.

### 2. FIELD OF THE INVENTION

The present invention relates to computer-implemented systems and methods for structured encoding, storage, and reconstruction of contextual data across interaction sessions. More particularly, the invention relates to a specific computer-implemented architecture in which contextual input is encoded into structured identifiers serving as primary keys for direct address-based memory object lookup, stored as memory objects within a directed graph relational data structure maintaining explicit typed directed relationships, and reconstructed into contextual state representations through a deterministic relational activation process—an architecture that eliminates search, ranking, similarity scoring, vector embedding-based retrieval, keyword-frequency scoring, learned text-to-identifier mapping, and probabilistic retrieval at every stage of the identification and activation process.

The invention further relates to: a session transition protocol enabling deterministic cross-session continuity through structured entry and exit stamp records encoded as typed directed edges within the relational data structure; a resonance-based activation mechanism enabling threshold-conditioned loop activation and anchoring point creation from the relational data structure without similarity search; and a cross-session drift detection mechanism enabling identification and mitigation of contextual inconsistencies across interaction sessions through structured portal crossing records and versioned memory object management.

The invention is applicable to artificial intelligence systems, natural language processing systems, interactive computing systems, and distributed or stateless computing environments requiring contextual continuity across independent interaction sessions.

### 3. BACKGROUND OF THE INVENTION

### 3.1 Limitations of Session-Bound Context Systems

Certain computational systems for processing contextual data operate within session-bound context windows. In such systems, contextual data accumulated during an interaction session may not persist beyond that session. When a new session is initiated, prior contextual data may not be available without manual reintroduction. As a result, contextual continuity across sessions may be limited, and relationships among contextual elements established in prior sessions may not be preserved or reactivated in subsequent sessions.

### 3.2 Limitations of Linea and Static Memory Storage

Certain systems employ static or linear storage structures for contextual data. In such systems, contextual elements may be stored in sequential or flat data structures that do not preserve relational associations among stored elements. Reconstruction of prior contextual states from such structures may require access to stored session-specific conversational content, which may be unavailable in distributed or stateless computing environments.

### 3.3 Limitations of Search-Dependent Memory Systems

Certain systems provide cross-session contextual continuity through mechanisms that require search—including probabilistic similarity search, embedding-based retrieval, vector similarity ranking, keyword-frequency scoring, learned mapping of input text to a label set of pre-existing identifiers, or graph traversal seeded through probabilistic similarity evaluation—at one or more stages of the memory object identification or activation process. In such systems, the identification of relevant memory objects depends on a search operation that computes similarity scores between a current input and stored data representations, ranks candidates, and returns the highest-scoring results. Such systems fundamentally require search as an architectural component: without the search operation, the system cannot identify which memory objects to activate. This search dependency introduces variable outputs across otherwise identical operations and precludes session-independent reconstruction.

Recent prior art memory systems for large language model agents—including hierarchical context management systems performing tier-to-tier retrieval through dense vector similarity, agent memory frameworks indexing memory streams by combined recency-importance-relevance scoring with vector similarity matching, knowledge-graph-as-retrieval-layer systems performing entity recognition via learned mapping followed by hybrid graph-and-vector retrieval, temporal knowledge graph engines performing hybrid search combining cosine similarity over high-dimensional entity embeddings with keyword-frequency scoring and graph traversal, agentic memory architectures constructing inter-memory links through learned semantic similarity analysis, and graph-augmented memory layers performing multi-signal retrieval across semantic embedding, keyword scoring, and entity-matching channels—collectively share a defining architectural characteristic: at one or more stages of memory object identification, link construction, or activation, the system computes a similarity metric between an input representation and one or more stored representations and uses the resulting score to select, rank, or filter memory objects. Such systems may differ from one another in retrieval modality, indexing structure, or scoring composition, but each is search-dependent in the architectural sense—none can identify which memory objects to activate without a similarity computation against the stored memory object population at one or more stages.

The claimed activation architecture is structurally distinct from each of the foregoing categories of prior art systems. The claimed activation architecture performs identification and activation of memory objects exclusively through direct address-based lookup using a structured identifier as a primary key and through deterministic traversal of typed directed relational references within a directed graph data structure. The claimed activation architecture computes no similarity metric between contextual input and stored memory representations at any stage of identification or activation, performs no embedding-based retrieval, performs no keyword-frequency scoring, performs no learned mapping of input text to a pre-existing identifier label set, and performs no ranking of candidate memory objects by similarity score.

### 3.4 Limitations of Session Transition Recordkeeping

Certain systems that provide cross-session contextual continuity do not maintain structured records of session boundaries within the relational data structure itself. In such systems, the transition between one interaction session and the next is not encoded as a traversable data structure element—it is instead managed through external session management systems, stored conversational logs, or user-supplied context reintroduction. As a result, the session boundary is not addressable by structured identifier, is not traversable through the relational data structure, and cannot serve as a deterministic activation seed for subsequent sessions. Systems lacking structured session transition records cannot provide deterministic cross-session reconstruction from the relational data structure alone.

### 3.5 Limitations of Resonance-Based and Spreading Activation Systems

Certain systems employ resonance scoring or threshold-based evaluation to identify relevant memory objects. However, in such systems the resonance computation operates as a similarity search: the system computes similarity scores between the current input and stored memory representations, compares those scores against a threshold, and activates memory objects whose scores exceed the threshold. Such systems require evaluation of similarity metrics between the input and stored representations at the threshold evaluation stage—they are search-dependent systems with a threshold filter, not threshold-conditioned systems operating without search. Additionally, such systems do not encode resonance scores as static attributes of relational references within a directed graph data structure set as system parameters prior to the activation operation, and do not generate anchoring point memory objects upon loop saturation as new addressable nodes within the relational data structure.

Classical spreading activation models of semantic memory—including those originating in cognitive science and subsequent computational adaptations—propagate activation along weighted edges of an associative network, with edge weights typically representing learned semantic similarity, co-occurrence frequency, or psychological distance between concepts. Such systems, while structurally graph-based and threshold-mediated, derive their edge weights from input-conditioned similarity computations or from training on corpora and apply propagation rules that do not produce new addressable memory objects upon saturation, do not maintain a structured identifier schema enabling cross-session addressability, and do not preserve activated subgraphs as first-class addressable entities within the relational data structure for subsequent deterministic activation.

The claimed resonance-based loop activation mechanism is structurally distinct from both threshold-filtered similarity search and classical spreading activation. In the claimed embodiment, threshold-based association criteria are pre-defined system parameters configured prior to the activation operation; the threshold operates exclusively on associative property values that are stored as static attributes of relational references within the directed graph at the time the relational references are created or updated; the threshold does not require, and does not invoke, any computation of similarity between the contextual input and stored memory object representations; and upon reaching a saturation condition, the loop activation sequence generates a new anchoring point memory object as an addressable node within the relational data structure, connected by typed directed edges to all memory objects activated during the loop activation sequence, such that the anchoring point is subsequently addressable across interaction sessions through its structured identifier.

### 3.6 Limitations of Cross-Session Drift Detection

Certain systems do not provide mechanisms for detecting or mitigating contextual inconsistencies that arise across interaction sessions. In such systems, if a memory object's contextual state has evolved since a prior session—due to changed circumstances, updated information, or temporal progression—the system has no structured mechanism for identifying the inconsistency, flagging the drift, or harmonizing the contextual state representation across sessions. The absence of cross-session drift detection means that contextual state representations may become stale, inconsistent, or inaccurate across sessions without the system having any structural mechanism to identify or correct the divergence.

Certain prior art systems implement bitemporal data models—representing both event time and ingestion or transaction time as attributes of stored facts—to capture the validity of data over time and to enable time-travel queries against historical states. Knowledge graph versioning frameworks, delta-based versioning systems, and ontology evolution frameworks similarly provide mechanisms for storing successive versions of graph-structured data and for retrieving historical states. Such systems address the storage and querying of versioned data; they do not provide a drift detection step that compares contextual metadata of corresponding memory objects across sessions through address-based primary key lookup, do not integrate the comparison step with structured session transition records as the access mechanism, and typically rely on similarity-based retrieval or time-range queries to surface the relevant historical states. The claimed cross-session drift detection mechanism is structurally distinct: it performs the comparison between memory objects retrieved through direct primary key lookup and not search-resolved candidates, evaluates divergence on specific stored attribute values rather than on derived embedding representations, and harmonizes detected drift through generation of a versioned successor memory object connected to the prior memory object by a typed directed supersession edge addressable by structured identifier.

### 3.7 Technical Need

Accordingly, there exists a need in the art for a specific computer-implemented architecture that: eliminates search, ranking, similarity scoring, vector embedding-based retrieval, keyword-frequency scoring, learned text-to-identifier mapping, and probabilistic similarity evaluation as architectural requirements for memory object identification and activation; provides structured session transition records encoded as typed directed edges enabling deterministic cross-session reconstruction from the relational data structure alone; provides resonance-based threshold activation operating on static relational reference attributes set as system parameters prior to the activation operation, including anchoring point creation at loop saturation as new addressable nodes; provides cross-session drift detection and mitigation through address-based comparison of stored attribute values and versioned memory object management; and produces reproducible, auditable, and structurally non-redundant contextual state representations—all without requiring session-specific conversational history to be retained or reintroduced.

### 4. SUMMARY OF THE INVENTION

### 4.1 Overview

The present invention provides a computer-implemented system and method that eliminates search as an architectural requirement for contextual memory object identification and activation, provides a structured session transition protocol enabling deterministic cross-session continuity, provides a resonance-based loop activation mechanism with anchoring point creation, and provides a cross-session drift detection and mitigation mechanism—all operating through address-based identifier lookup and relational reference traversal without the foregoing search-dependent mechanisms at any stage.

### 4.2 Structured Identifier Encoding

In some embodiments, contextual input is processed to generate a structured identifier organized in accordance with the schema: [EUID]-[CATEGORY]-[TAG]-[DATE]-[VERSION]. EUID is a fixed system-level prefix. The variable attribute-encoding fields are: CATEGORY encoding a classification of the contextual element from a defined set of categories; TAG encoding a semantic descriptor within the category from a defined lexicon; DATE encoding temporal information; and VERSION encoding a version or revision indicator. The structured identifier is generated through direct extraction of attribute values from the contextual input, in accordance with the schema, and is not generated through learned mapping or classification of the contextual input to a pre-existing label set of identifiers stored in the relational data structure. The structured identifier serves as a primary key for direct address-based memory object lookup within the graph-based data storage system, enabling identification of memory objects without search, ranking, embedding-based retrieval, or similarity computation across the stored population.

### 4.3 Memory Object Construction and Storage

In some embodiments, a memory object comprises the structured identifier serving as a primary key, contextual metadata comprising data attributes directly associated with the contextual element, and one or more relational references each containing the structured identifier of the referenced memory object and the relationship type. Memory objects are stored as nodes in the directed graph with typed directed edges to referenced memory objects.

### 4.4 Relational Data Structure

In some embodiments, the relational data structure comprises a directed graph in a graph-based data storage system in which memory objects are represented as nodes addressable by their structured identifiers and relational references are represented as typed directed edges encoding temporal relationships, semantic relationships, or contextual associations.

### 4.5 Deterministic Address-Based Activation

In some embodiments, upon receipt of new contextual input, a processing engine identifies candidate memory objects through direct primary key lookup using the structured identifier generated for the input—without search, similarity evaluation, or the foregoing retrieval mechanisms. The processing engine then applies pre-defined activation conditions comprising a traversal rule: a candidate memory object is activated when a relational reference stored within a currently activated memory object contains the structured identifier of the candidate memory object. Activation propagates along directed relational references from activated nodes to referenced nodes through address-based identifier matching, without evaluation of similarity metrics at any stage. Identical pre-defined activation conditions applied to identical relational data structure state produce identical activated sets.

### 4.6 Session Transition Protocol

In some embodiments, the system maintains session transition records within the relational data structure, each comprising a structured exit identifier associated with the conclusion of one interaction session and a corresponding structured entry identifier associated with the initiation of a subsequent interaction session. Session transition records are encoded as typed directed edges connecting memory objects activated at session conclusion to memory objects activated at session initiation, enabling traversal of the relational data structure across session boundaries through address-based identifier matching—without requiring prior session conversational content to be retained or reintroduced and without similarity computation between the contextual input of a current session and stored memory representations of prior sessions.

### 4.7 Resonance-Based Loop Activation and Anchoring

In some embodiments, the processing engine applies a threshold-based association criterion to relational references within the relational data structure. The threshold-based association criterion is a pre-defined activation condition: a system parameter configured prior to the activation operation specifying a minimum associative property value that a relational reference must satisfy for activation to propagate along that reference. The threshold-based association criterion operates on associative property values stored as static attributes of relational references within the directed graph, set at the time the relational references are created or updated, and does not invoke any computation of similarity between the contextual input and stored memory object representations at activation time. Upon saturation, the processing engine generates an anchoring point memory object encoded as a new node in the relational data structure, connected by typed directed edges to all memory objects activated during the loop, addressable by structured identifier across interaction sessions.

### 4.8 Cross-session Drift Detection and Mitigation

In some embodiments, the processing engine monitors contextual consistency by comparing stored attribute values of memory objects activated in a current session against stored attribute values of corresponding memory objects from prior sessions, identified through direct primary key lookup via the session transition protocol. The comparison is performed on stored attribute values rather than on derived embedding representations and does not constitute a search across the stored memory object population. When divergence exceeds a configured consistency threshold set as a pre-defined system parameter, the processing engine generates a drift indicator and triggers harmonization comprising: generating a versioned successor memory object; creating a typed directed supersession edge; and updating session transition records. Drift detection and harmonization operate without search, ranking, or similarity evaluation at any stage.

### 4.9 Contextual State Representation

The processing engine constructs a contextual state representation comprising two defined components: (1) an aggregation of contextual metadata from the activated memory objects; and (2) relational context comprising information derived from the types, directions, and attributes of the directed edges connecting the activated nodes. The two components are structurally non-redundant—the first is derived from node attributes, the second from edge attributes—and together constitute a reconstruction that neither component could produce in isolation.

### 4.10 Modes of Operation

In some embodiments, the system may operate in a manual mode, a semi-automated mode, or an automated mode. The system may transition between modes depending on implementation requirements or system configuration.

### 4.11 the Combination as the Invention

The inventive contribution of the present system is not any single component taken in isolation. The invention resides in the specific combination of: a structured multi-field identifier schema enabling primary-key address-based lookup with attribute extraction-based identifier generation; a directed graph relational data structure with typed directed edges; a deterministic relational activation process eliminating search, embedding-based retrieval, keyword-frequency scoring, and learned text-to-identifier mapping at every stage; a session transition protocol encoding session boundaries as typed directed edges traversable by structured identifier; a resonance-based loop activation mechanism with anchoring point creation operating on pre-stored static relational reference attributes without similarity search; and a cross-session drift detection and mitigation mechanism operating through address-based comparison of stored attribute values without similarity computation. This specific combination is not present in, disclosed by, or suggested by any single prior art reference or combination of prior art references.

### 5. Statement of Specific Technical Improvement

The claimed invention provides specific technical improvements to computer-implemented contextual data management systems. These improvements are not merely the application of an abstract idea using generic computer components performing generic functions. The core architectural improvements collectively eliminate search as an architectural requirement for memory object identification and activation, provide deterministic session boundary encoding, enable threshold-conditioned loop activation from graph structure alone, and provide cross-session drift detection through relational data structure traversal.

### First Technical Improvement—Deterministic Primary-Key Addressing via Structured Schema

The structured multi-field identifier schema provides a primary-key addressing mechanism enabling direct address-based memory object lookup without search, ranking, embedding-based retrieval, keyword-frequency scoring, learned text-to-identifier mapping, or computation of similarity metrics. This is a specific improvement to how a computing system addresses stored data records—analogous to the improvement recognized in Enfish, LLC v. Microsoft Corp., 822 F. 3d 1327 (Fed. Cir. 2016). The structured identifier schema provides a session-independent primary key enabling consistent memory object addressing across interaction sessions. The structured identifier is generated through direct extraction of attribute values from the contextual input in accordance with a defined schema and not through trained mapping or classification to a pre-existing label set.

### Second Technical Improvement—Directed Graph With Typed Directed Edges

The relational data structure comprising memory objects as nodes and relational references as typed directed edges provides a specific data architecture preserving relational associations across multiple interaction sessions. Typed directed edges enable structured multi-dimensional traversal across temporal, semantic, and contextual relationship dimensions that flat storage structures and session-bound context windows cannot provide.

### Third Technical Improvement—Elimination of Search as Architectural Requirement

Unlike systems that identify relevant memory through probabilistic similarity search, the present invention performs direct identifier-based addressing and deterministic relational activation without ranking, scoring, or search at any stage of the identification or activation process. The claimed activation architecture performs no embedding-based retrieval, no keyword-frequency scoring, no learned text-to-identifier mapping, and no similarity computation between contextual input and stored memory object representations. This is a specific architectural improvement in kind: prior art memory systems for large language model agents—including hierarchical context management systems, agent memory frameworks with composite recency-importance-relevance retrieval, knowledge-graph-as-retrieval-layer systems, temporal knowledge graph engines with hybrid search, agentic memory architectures with similarity-driven link construction, and graph-augmented multi-signal retrieval systems—collectively share a defining architectural characteristic that the claimed activation architecture eliminates.

### Fourth Technical Improvement—Two-Component Contextual State Representation

The output is a structured contextual state representation comprising two defined non-redundant components: aggregated contextual metadata from activated memory objects (node-derived) and relational context derived from edge attributes (edge-derived). The two components carry structurally non-redundant information; neither can be derived from the other; together they constitute a reconstruction that neither component alone could produce. This structural distinction supports patentability under § 101 as a defined data structure with a defined construction method.

### Fifth Technical Improvement—Session Transition Protocol Encoded In-Graph

Session boundaries are encoded as typed directed edges within the relational data structure, with exit-stamp and entry-stamp memory objects each addressable by structured identifier. This in-graph encoding enables deterministic cross-session reconstruction through address-based traversal of the relational data structure alone, without reliance on external session management systems, stored conversational logs, or similarity-based retrieval of prior session context.

### Sixth Technical Improvement—Session-Independent Reconstruction

The system reconstructs contextual state from structured memory objects and their directed relational references without requiring session-specific conversational history to be retained, reintroduced, or accessed. A memory object created in one session can be directly addressed and activated in any subsequent session using the same structured identifier.

### Seventh Technical Improvement—Resonance-based Loop Activation With Anchoring

The threshold-based association criterion operates on associative property values stored as static attributes of relational references within the directed graph and set as system parameters prior to the activation operation. The criterion does not invoke any similarity computation at activation time. Upon saturation, the system generates an anchoring point memory object as a new addressable node, connected by typed directed edges to all memory objects activated during the loop, addressable across interaction sessions. This mechanism is structurally distinct from threshold-filtered similarity search and from classical spreading activation, neither of which produces new addressable memory objects upon saturation or maintains cross-session addressability of activated subgraphs.

### Eighth Technical Improvement—Address-Based Cross-Session Continuity

Cross-session continuity is achieved through traversal of session transition records encoded as typed directed edges within the relational data structure. The system addresses memory objects from prior sessions through their structured identifiers—without similarity computation, without retrieval of session-specific conversational content, and without ranking.

### Ninth Technical Improvement—Cross-Session Drift Detection and Mitigation

The cross-session drift detection and mitigation mechanism provides a specific technical improvement enabling contextual integrity management across distributed interaction sessions without similarity search. Prior art bitemporal data models, knowledge graph versioning frameworks, and ontology evolution systems address the storage and querying of versioned data; they do not couple version management with address-based contextual consistency evaluation across structured session transition records, and they typically rely on similarity-based retrieval or time-range queries to surface relevant historical states. The claimed drift detection mechanism operates entirely through address-based identifier lookup and relational reference traversal, producing a deterministic drift assessment from graph structure alone.

### Tenth Technical Improvement—Concrete, Verifiable Technical Effects

The claimed invention produces specific, concrete, and verifiable technical effects not produced by prior art systems. First, the deterministic activation mechanism produces fully reproducible results: identical activation conditions applied to an identical relational data structure state produce an identical activated set and an identical contextual state representation, every time. This reproducibility enables verification, auditing, and testing of contextual state reconstruction in a manner that probabilistic retrieval systems—whose outputs vary across otherwise identical operations—fundamentally cannot support.

Second, the two-component contextual state representation is a defined non-redundant data structure—Component One derived from node attributes, Component Two derived from edge attributes, neither derivable from the other—generated by a specific multi-step structural operation involving address-based traversal, not retrieved from storage. This structural output is a concrete technical artifact, distinct from the memory objects it was reconstructed from and distinct from any stored session-specific conversational record.

Third, the in-graph session transition record architecture enables cross-session contextual continuity without retaining or accessing session-specific conversational content. This reduces the storage and computational resources required for cross-session operation in stateless computing environments: the system need not maintain full conversation logs, need not re-process prior session transcripts, and need not perform computationally expensive retrieval operations at session start.

These concrete technical effects—reproducibility of reconstruction, structural non-redundancy of the two-component output, and stateless cross-session continuity—support patent eligibility under 35 U.S.C. § 101 as specific technical improvements to computer-implemented contextual data management systems. See McRO, Inc. v. Bandai Namco Games America Inc., 837F. 3d 1299 (Fed. Cir. 2016) (specific rules applied to a specific computing task, producing a result the prior art could not produce by conventional means, are patent-eligible); Enfish, LLC v. Microsoft Corp., 822 F. 3d 1327 (Fed. Cir. 2016) (specific improvement to the way a computer stores and retrieves data, resulting in a more efficient computing system, is patent-eligible). The claimed system improves the way a computing system reconstructs contextual state across interaction sessions by eliminating search as an architectural requirement and producing a deterministic, reproducible, structurally non-redundant output—improvements in kind, not merely in degree, relative to prior art retrieval-based systems.

The foregoing technical improvements characterize the claimed activation architecture as implemented in the described embodiments. The claimed system and method perform identification and activation of memory objects without search, similarity scoring, vector embedding-based retrieval, keyword-frequency scoring, learned text-to-identifier mapping, or probabilistic similarity evaluation at any stage of the identification and activation process. This characterization is specific to the identification and activation pathway as claimed. The described embodiments do not exclude future system implementations from incorporating probabilistic, statistical, or embedding-assisted components for purposes external to the claimed identification and activation pathway—including response generation, natural language output formatting, user interface rendering, or auxiliary processing operations—provided such components do not participate in the identification or activation of memory objects as claimed herein.

### 6. BRIEF DESCRIPTION OF THE DRAWINGS

The accompanying drawings are incorporated in and constitute a part of this specification. Drawings should be submitted separately per 37 C.F.R. § 1.53. In the drawings, like reference numerals designate like parts throughout.

FIG. 1—System architecture overview. Vertical flow diagram: Input Interface (100)→Structured Identifier Module (110)—attribute extraction, not learned mapping→Memory Object Store (120)→Relational Data Structure (130) directed graph→Processing Engine (140) with sub-functions: address-based lookup, activation condition application, iterative traversal, two-component construction→Contextual State Representation Output (150)→Downstream Processing Influence (160). Dotted feedback arc (150→110). Right-side label: ‘No search, ranking, similarity scoring, embedding-based retrieval, keyword-frequency scoring, or learned text-to-identifier mapping at any stage. Reproducible: identical inputs produce identical outputs.’

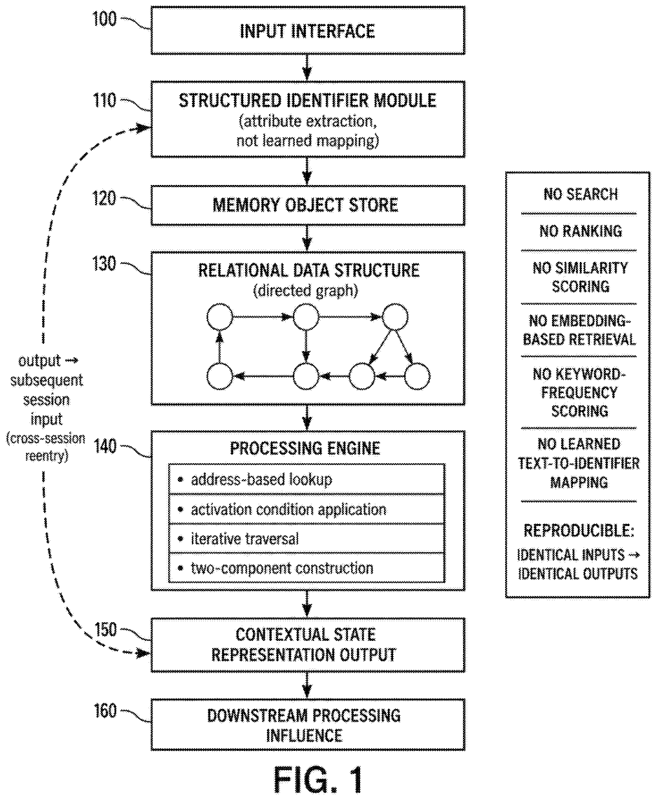

FIG. 2—Data processing pipeline. Six stages: Input Reception (200)→Contextual Parsing (210) →Attribute Extraction (220) →Identifier Generation (230)—‘Generated by direct attribute extraction, not by learned mapping’→Validation (240)→Storage (250). Example: EUID-PEOPLE-FOUNDER-20250505-v1.

FIG. 3—Recursive activation. Circular loop: Contextual Input (300)→Identifier Generation (310)→Primary Key Lookup (320) ‘no search, no embedding similarity, no keyword scoring’→Activation Conditions (330)→Activated Objects (340)→Recursive Activation (360)→Contextual State Representation (370). Feedback arc (380). Label: ‘Identical inputs→identical outputs—reproducible.’

FIG. 4—Lexicon-based data organization. Hierarchical tree with category clusters (People, Events, Locations, Concepts, Artifacts, Extensible). Example identifiers per cluster. Label: ‘TAG drawn from defined lexicon. Identifier generated by direct attribute extraction.’

FIG. 5—Relational memory structure with session transition protocol. Three session bands with exit-stamp and entry-stamp nodes connected by typed directed edges as in-graph session transition records. Event-Based Anchor Node (524). Label: ‘Session boundaries are first-class in-graph nodes, addressable by structured identifier—not external session management.’

FIG. 6—Structured identifier schema. Five fields: [EUID]|[CATEGORY]|[TAG]|[DATE]|[VERSION]. Label: ‘Generated by direct attribute extraction. Not selected from pre-existing label set.’

FIG. 7—Anchoring and loop saturation. Event-Based Anchor left part. Loop Saturation right part: Threshold evaluation on pre-stored static edge attributes→Loop→Saturation→New Anchoring Point Memory Object. Label: ‘Threshold operates on static edge attributes set as system parameters. Saturation generates new addressable node. Distinct from spreading activation.’

FIG. 8—Cross-session drift detection. Three-column diagram: Session A (M1 v1, addressed by primary key) |Drift Detection Layer (primary key lookup via session transition record, attribute-by-attribute comparison, drift indicator, harmonization)|Session B (M1-v2, supersession edge, updated session transition record). Label: ‘Comparison on stored attribute values, not embeddings. Primary key lookup, not search.’

### 7. DETAILED DESCRIPTION OF THE INVENTION

The following detailed description provides illustrative embodiments of systems and methods for encoding, storing, and reconstructing contextual data using structured identifiers and relational memory structures, with session transition protocol, resonance-based loop activation, and cross-session drift detection. The described embodiments are illustrative and not limiting. The core architectural principle of the described embodiments is the elimination of search as a required component of memory object identification and activation, replacing search-dependent retrieval with address-based lookup and deterministic relational activation.

### 7.1 System Overview

The present invention provides a computer-implemented system configured to process contextual data and generate contextual state representations across interaction sessions. The system comprises, in some embodiments: an input interface (100) configured to receive contextual input; a structured identifier module (110) configured to generate structured identifiers in accordance with the schema [EUID]-[CATEGORY]-[TAG]-[DATE]-[VERSION] through attribute extraction from the contextual input; a memory object store (120) configured to store a plurality of memory objects; a relational data structure (130) implemented as a directed graph; a processing engine (140) configured to identify memory objects through address-based primary key lookup, apply pre-defined activation conditions, and construct contextual state representations; and a contextual state representation output (150). The contextual state representation is provided to a downstream processing influence component (160).

### 7.2 Contextual Input Processing

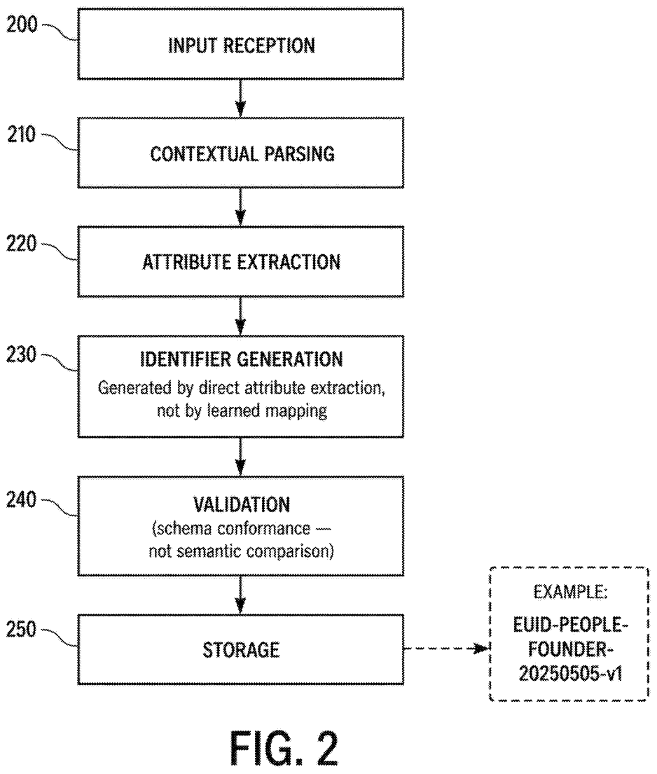

The system processes contextual input through a structured data pipeline illustrated in FIG. 2. The system receives contextual input including textual input, symbolic input, event-based input, or audio input (200). Contextual parsing (210) identifies semantic descriptors, categorical classifications, temporal information, and contextual relationships. Attribute extraction (220) identifies semantic content, category, temporal data, and contextual metadata. Identifier generation (230) produces the structured identifier serving as primary key by direct extraction of attribute values from the contextual input in accordance with the schema. Validation (240) cross-checks completeness, consistency, and uniqueness. Storage (250) incorporates the memory object into the relational data structure as a node with typed directed edges.

### 7.3 Structured Identifier Assignment

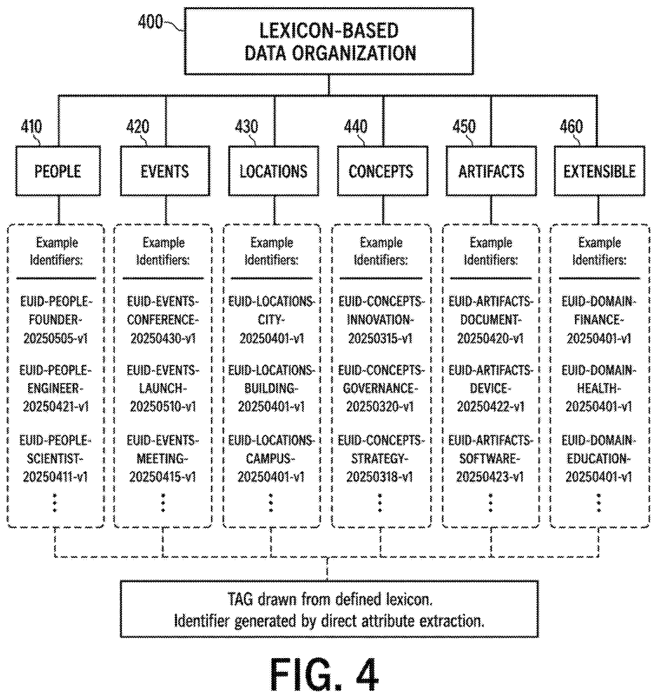

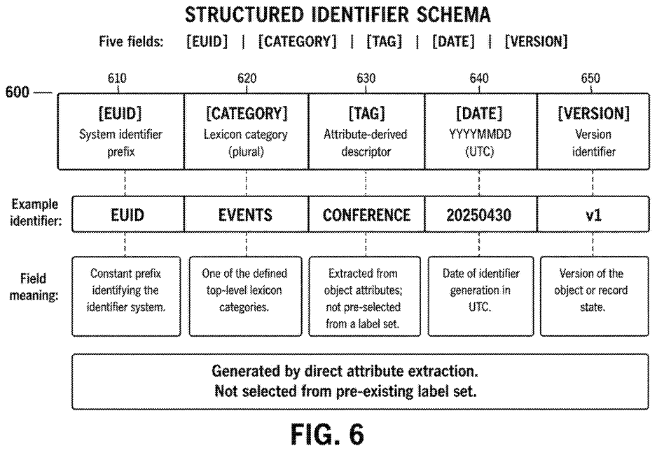

Following contextual input processing, the system generates a structured identifier organized in accordance with the schema illustrated in FIG. 6 (600): [EUID](610)|[CATEGORY] (620)|[TAG] (630)|[DATE] (640)|[VERSION] (650). EUID (610) is a fixed system-level prefix—in some embodiments the literal string ‘EUID.’ The variable attribute-encoding fields are: CATEGORY (620), a field encoding a high-level classification drawn from a defined set including people, events, locations, concepts, and artifacts; TAG (630), a field encoding a semantic descriptor within the category drawn from a defined lexicon; DATE (640), a field encoding temporal information; and VERSION (650), a field encoding a version or revision indicator. The defined category set is organized in the lexicon-based hierarchy illustrated in FIG. 4 (400), comprising category clusters including PEOPLE (410), EVENTS (420), LOCATIONS (430), CONCEPTS (440), ARTIFACTS (450), and an extensible set of additional categories (460). The structured identifier is generated through direct extraction of attribute values from the contextual input in accordance with the schema and the defined category and lexicon sets, and is not generated through trained mapping or classification of the contextual input to a label set of pre-existing identifiers stored in the relational data structure. The structured identifier serves as a primary key for direct address-based node lookup without search, ranking, embedding-based retrieval, keyword-frequency scoring, or computation of similarity metrics. Illustrative examples: EUID-PEOPLE-FOUNDER-20250505-v1 and EUID-EVENTS-SESSION-20250505-v1.

In some embodiments, the defined set of categories is extensible to include additional categories including crystallizations of conceptual insights arising from interaction sessions, protocols governing system interaction parameters, session transition records documenting entry and exit boundaries between interaction sessions, directional associative links between memory structures, and emotional state representations—each drawn from a defined set and associated with a defined lexicon of semantic descriptors within that category.

Direct extraction, as used herein, refers to the generation of a structured identifier from the contextual input by identifying and assigning attribute values to the identifier's fields in accordance with the defined schema and the defined category and lexicon sets. Direct extraction may employ natural language processing techniques—including named entity recognition, date parsing, categorical classification, and semantic parsing—to identify the attribute values present in the contextual input; such techniques are applied to the contextual input to extract its own attributes, not to compare the contextual input against stored memory objects. As an illustrative example: given contextual input describing a person named Scott Frankel, co-founder of a project, with a reference date of May 5, 2025, the structured identifier module extracts CATEGORY=PEOPLE, TAG=SFRANKEL, DATE=20250505, and VERSION=v1 from the attributes of the input itself, producing EUID-PEOPLE-SFRANKEL-20250505-v1. The production of this identifier does not involve consulting any existing identifier in the relational data structure, comparing the input against any existing memory object, or selecting an identifier from a pre-existing label set.

Direct extraction is distinguished from trained mapping or classification of the contextual input to a pre-existing label set of identifiers stored in the relational data structure. In trained mapping, a learned model produces as output an identifier selected from an existing set of identifiers, based on the model's training to predict which existing identifier best matches or corresponds to the input. In direct extraction, the output identifier is constructed from attribute values of the input itself in accordance with a defined schema, and is newly generated even if no prior memory object exists in the relational data structure for the contextual element being encoded. Trained mapping identifies existing identifiers by similarity; direct extraction generates new identifiers by attribute assignment. The present invention performs the latter.

### 7.4 Memory Object Construction

Each memory object comprises: the structured identifier as a primary key; contextual metadata comprising data attributes directly associated with the contextual element; and one or more relational references each containing the structured identifier of the referenced memory object and the relationship type. Memory objects are stored as nodes in the directed graph with typed directed edges to referenced memory objects. A contextual state representation may be used to generate additional memory objects incorporated as new nodes with associated typed directed edges.

### 7.5 Relational Memory Structure

The relational data structure is implemented as a directed graph. Each typed directed edge encodes: the structured identifier of the source node; the structured identifier of the target node; and the relationship type, including temporal relationships, semantic relationships, or contextual associations. Memory objects are grouped within interaction sessions and connected across session boundaries through cross-session relational linkages. In some embodiments, traversal is limited to a defined traversal depth specifying a maximum number of directed edge traversal steps.

Relational reference attributes designated as associative property values—including resonance threshold values used in the loop activation mechanism of § 7.10—are static with respect to the activation operation: their values are set at the time the relational reference is created or updated, in accordance with system configuration parameters set prior to the activation operation, and are not derived during the activation operation from the contextual input or from any computation performed on the contextual input. Static, in this context, does not mean permanently immutable in the system's lifecycle. Relational reference attributes may be updated through a separate update operation—for example, when a relationship evolves over time and the associative property value is reconfigured to reflect the evolved strength of the relationship. The update operation is distinct from the activation operation. Within any given activation operation, the attribute values present on relational references are fixed prior to the operation's commencement and do not change as a function of the contextual input received in that activation cycle. This is the defining distinction from classical spreading activation and threshold-filtered similarity search systems, in which weights or scores may be derived or modified at query time based on the contextual input.

### 7.6 Deterministic Address-based Contextual State Reconstruction

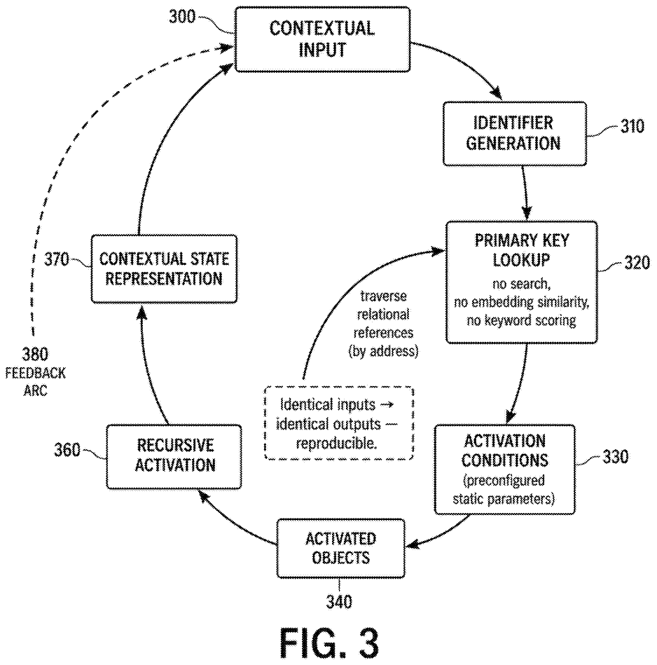

The system reconstructs contextual state through a deterministic address-based activation process illustrated in FIG. 3. Upon receiving contextual input (300), the system generates a structured identifier (310) through attribute extraction in accordance with the schema, and performs a direct primary key lookup (320)—without search, ranking, embedding-based retrieval, keyword-frequency scoring, learned text-to-identifier mapping, or similarity evaluation. The processing engine (330) applies pre-defined activation conditions. A first set of memory objects (340) satisfying the conditions is activated. Recursive activation (360) proceeds through traversal of directed relational references until the defined traversal depth is reached or no additional memory objects satisfy the conditions. The feedback arc (380) indicates generation of new memory objects from the contextual state representation. The contextual state representation (370) is constructed from the activated set.

### 7.6.1 Pre-defined Activation Conditions

Pre-defined activation conditions are system parameters configured prior to the activation operation and applied consistently across activation cycles. A pre-defined activation condition comprises a traversal rule specifying that a candidate memory object is activated when a relational reference stored within a currently activated memory object contains the structured identifier of the candidate memory object. Activation does not require evaluation of similarity metrics, computation of vector embeddings, computation of keyword-frequency scores, learned mapping to a pre-existing identifier label set, or ranking of candidate memory objects at any stage. Identical pre-defined activation conditions applied to identical relational data structure state produce identical activated sets.

In certain embodiments, activation conditions may include threshold-based association criteria specifying that activation propagates along a relational reference when an associative property encoded by that relational reference satisfies a defined threshold value configured as a system parameter prior to the activation operation. Such threshold-based criteria operate on static relational reference attributes within the relational data structure—set at the time the relational references are created or updated—and do not require computation of similarity metrics, vector embeddings, or keyword-frequency scores, and do not perform search across the stored memory object population.

### 7.6.2 Multi-Object Activation and Combination

The system activates multiple memory objects and combines their contextual data to construct a contextual state representation comprising aggregated contextual metadata and relational context from typed directed edges. In some embodiments, the contextual state representation is used to generate additional memory objects incorporated as new nodes with associated directed edges.

### 7.6.3 Iterative and Layered Reconstruction

The reconstruction process is iterative. Activation of a first set of memory objects leads to identification and activation of additional memory objects through directed relational references. This continues until no additional memory objects satisfy the pre-defined activation conditions or the defined traversal depth is reached. Upon completion, in some embodiments the processing engine records a termination state indicating the activation process is complete and identifying the final activated set.

### 7.7 Contextual State Representation

The contextual state representation is constructed as a structured output artifact comprising two defined components: (1) Contextual metadata aggregation—an aggregation of contextual metadata from the activated memory objects, comprising data attributes directly associated with each activated memory object; and (2) Relational context—information derived from the explicit directed relationships among activated memory objects, comprising the types, directions, and attributes of the directed edges connecting the activated nodes. Because the first component is derived from node attributes and the second from edge attributes, the two components are structurally non-redundant—neither can be derived from the other. The contextual state representation is a reconstructed artifact, not a retrieved record.

### 7.8 Contextual Influence on Processing

The contextual state representation is provided to downstream processing components (160) to influence subsequent processing of contextual input including interpretation, response generation, or other system behavior.

### 7.9 Session Transition Protocol

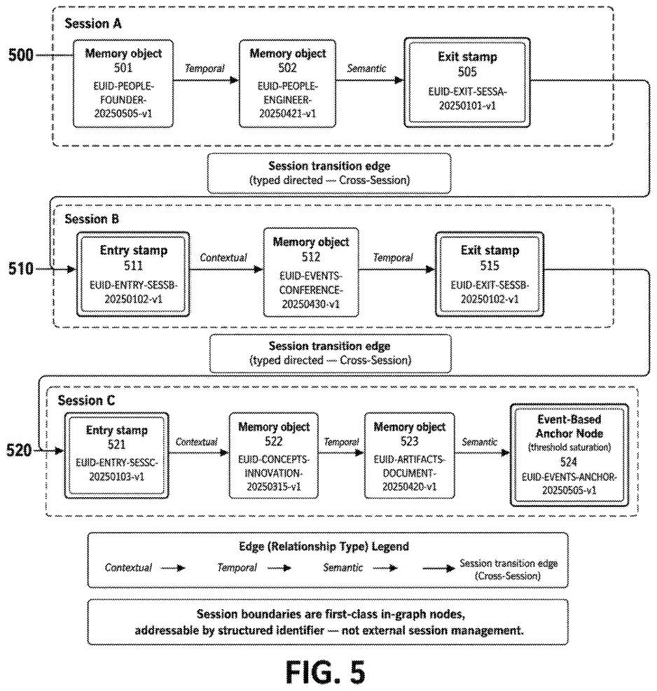

In some embodiments, the system maintains session transition records within the relational data structure, each comprising a structured exit identifier associated with the conclusion of one interaction session and a corresponding structured entry identifier associated with the initiation of a subsequent interaction session, as illustrated in FIG. 5 (500). FIG. 5 illustrates three interaction sessions: Session A (500), Session B (510), and Session C (520). Session A (500) contains memory objects (501, 502) connected by typed directed edges and concludes with an exit-stamp memory object (505). Session B (510) initiates with an entry-stamp memory object (511), contains memory object (512), and concludes with exit-stamp memory object (515). Session C (520) initiates with entry-stamp memory object (521), contains memory objects (522) and (523), and includes an Event-Based Anchor Node (524) generated upon loop saturation as described in § 7.10. Session transition records encode the temporal boundary between interaction sessions as typed directed edges connecting memory objects activated at session conclusion to memory objects activated at session initiation, enabling traversal of the relational data structure across session boundaries through address-based identifier matching.

The exit-stamp memory object associated with a session conclusion—illustrated by exit-stamp nodes (505) in Session A and (515) in Session B of FIG. 5—comprises: a structured identifier organized in accordance with the schema; contextual metadata encoding the session conclusion state including active memory object identifiers; and one or more relational references connecting to memory objects activated at session conclusion. The entry-stamp memory object associated with a subsequent session initiation—illustrated by entry-stamp nodes (511) in Session B and (521) in Session C of FIG. 5—comprises: a structured identifier organized in accordance with the schema; contextual metadata encoding the session initiation state; and a relational reference to the corresponding exit-stamp memory object, enabling bidirectional traversal of the session boundary within the relational data structure.

Session transition records serve as anchor points for subsequent deterministic activation of memory objects associated with prior interaction sessions. Upon initiation of a new interaction session, the processing engine identifies the entry-stamp memory object associated with the session through direct primary key lookup using its structured identifier—not through similarity computation between the contextual input of the new session and stored memory representations of prior sessions, not through ranking of candidate entry-stamp memory objects, and not through search across the stored memory object population. The processing engine activates the entry-stamp memory object and propagates activation through its relational references to reconstruct the contextual state of the prior session—without requiring prior session conversational content to be retained or reintroduced. This session transition protocol enables deterministic cross-session reconstruction from the relational data structure alone.

The session transition protocol described herein is structurally distinct from session management approaches that maintain session records external to the relational data structure. In such external approaches, a session boundary may be represented by a database transaction log, an external session token, a cookie or session identifier stored in a separate system, or a user-supplied context summary reintroduced as a prompt at the start of the next session. In the claimed system, the session boundary is encoded within the relational data structure itself: the exit-stamp and entry-stamp memory objects are first-class nodes in the directed graph, each assigned a structured identifier and addressable by that identifier. The typed directed edge connecting them—the session transition record—is itself traversable by the same address-based activation mechanism that traverses all other relational references. This in-graph encoding means the session boundary occupies the same address space as all other memory objects: it can serve as the starting address for an activation traversal, it can be connected to active memory objects by typed edges, and it can be versioned and evolved through the same succession mechanism as any other memory object. An external session record cannot serve as an activation seed for the address-based traversal mechanism because it is not addressable within the relational data structure.

### 7.10 Resonance-Based Loop Activation and Anchoring Point Creation

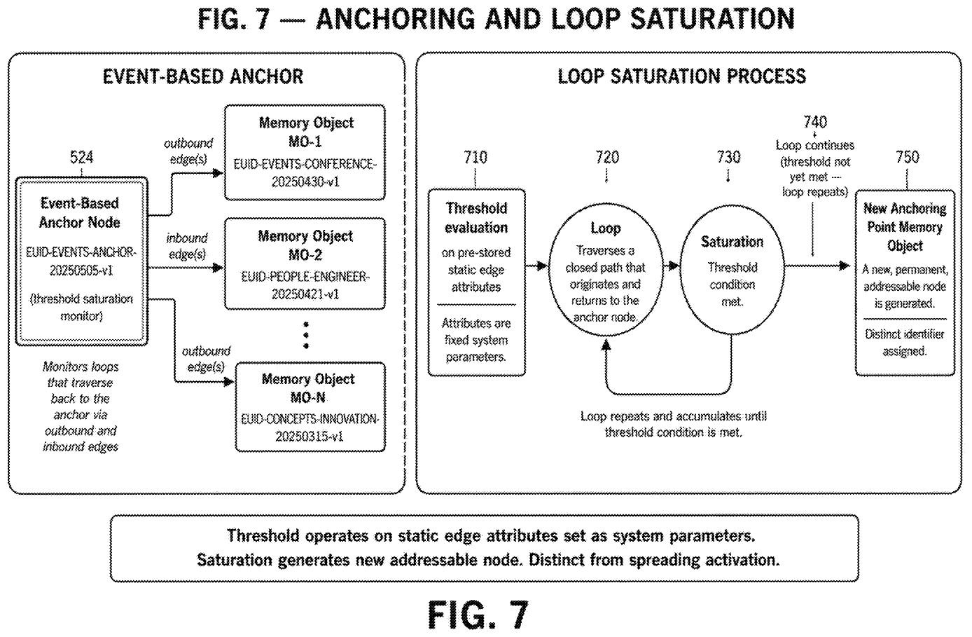

In some embodiments illustrated in FIG. 7, the processing engine applies a threshold-based association criterion to relational references within the relational data structure, as shown in the threshold evaluation step (710) of FIG. 7. The threshold-based association criterion is a pre-defined activation condition: a system parameter configured prior to the activation operation specifying a minimum associative property value—a resonance threshold—that a relational reference must encode for activation to propagate along that reference. Resonance threshold values are encoded as static attributes of relational references within the directed graph, set at the time the relational reference is created or updated, and represent the strength of associative connection between the source and target memory objects as determined at that time. The threshold-based association criterion does not invoke any computation of similarity between the contextual input and stored memory object representations at activation time; it does not invoke vector embedding of the contextual input; it does not invoke keyword-frequency scoring; and it does not invoke ranking of candidate memory objects against the contextual input.

When the threshold-based association criterion is satisfied across a propagating activation sequence—that is, when each relational reference traversed during iterative activation encodes an associative property value meeting or exceeding the configured resonance threshold—the processing engine initiates or continues a loop activation sequence (720). The loop activation sequence (720) iteratively activates connected memory objects through relational reference traversal until no additional relational references satisfy the threshold-based association criterion or a saturation condition (730) is reached. Where the threshold-based association criterion is not yet met across all traversed references, the loop repeats and accumulates (740) until the saturation condition (730) is reached.

Upon reaching the saturation condition (730), the processing engine generates an anchoring point memory object (750) encoded as a new node in the relational data structure, as illustrated in FIG. 7. The anchoring point memory object (750) comprises: a structured identifier organized in accordance with the schema; contextual metadata encoding the saturation state of the loop activation sequence; and typed directed edges connecting the anchoring point (750) to each memory object activated during the loop activation sequence, including memory objects such as the Event-Based Anchor Node (524) illustrated in FIG. 5 representing the anchoring point within the session structure. The anchoring point memory object (750) is stored within the memory object store and incorporated into the relational data structure, enabling subsequent deterministic activation of the anchoring point and its relational neighborhood through address-based identifier lookup without search.

The claimed resonance-based loop activation mechanism described herein differs fundamentally from threshold-filtered similarity search and from classical spreading activation. In threshold-filtered similarity search, the threshold is applied to similarity scores computed at query time between the input and stored representations; in classical spreading activation, edge weights are typically derived or modified at activation time based on the contextual input or based on computed similarity between the input and stored representations, and propagation rules do not produce new addressable memory objects upon saturation or maintain a structured identifier schema enabling cross-session addressability. In the claimed embodiment, the resonance threshold criterion operates on associative property values stored as static attributes of relational references within the directed graph, set as system parameters prior to the activation operation and not derived at activation time from any input-conditioned similarity computation; the criterion does not compute similarity metrics between the contextual input and stored memory representations; the criterion does not rank candidate memory objects; and the criterion does not perform search across the stored memory object population. Upon saturation, the claimed system generates a new addressable anchoring point memory object as a first-class node in the relational data structure, enabling subsequent deterministic activation of the anchoring point across interaction sessions through address-based identifier lookup.

The documented performance metrics associated with the resonance-based loop activation mechanism—including fidelity score increases from approximately 80% to 93% across primary narrative threads and thread reactivation rates from approximately 70% to 91% across distributed session sequences—demonstrate the continuity outcomes produced by the claimed relational data architecture and threshold-based activation conditions prior to the provisional filing date of May 5, 2025, as disclosed in U.S. Provisional Application No. 63/799,772.

In some embodiments, associative property values are drawn from a defined numeric scale, such as a range from 0.0 to 1.0, where higher values indicate stronger associative connection between the source and target memory objects. A configured resonance threshold might be set at a system parameter value of 0.7, causing the loop activation sequence to propagate only along relational references whose encoded associative property value is 0.7 or greater. In alternative embodiments, associative property values are drawn from a defined ordinal categorical scale, such as WEAK/MODERATE/STRONG/FOUNDATIONAL, with the resonance threshold configured to initiate loop activation only for relational references encoded as STRONG or FOUNDATIONAL. The specific scale, the permissible values within the scale, and the configured threshold value are all system parameters set prior to the activation operation and independent of the contextual input received at activation time.

A saturation condition is reached, and the anchoring point memory object is generated, when one of the following pre-defined conditions—enumerated as alternatives in Claim 22—is met: (i) no additional relational references within the currently activated subgraph encode associative property values satisfying the resonance threshold; (ii) a defined maximum loop depth—a system parameter specifying the maximum number of iterative activation steps—has been reached; or (iii) a defined saturation proportion threshold—a system parameter specifying the maximum proportion of the traversable relational data structure that the loop activation sequence is permitted to activate—has been reached. The saturation condition definition is itself a pre-defined system parameter, configured prior to the activation operation. Upon meeting any one of these conditions, the processing engine generates the anchoring point memory object as a new addressable node in the relational data structure.

### 7.11 Cross-session Drift Detection and Mitigation

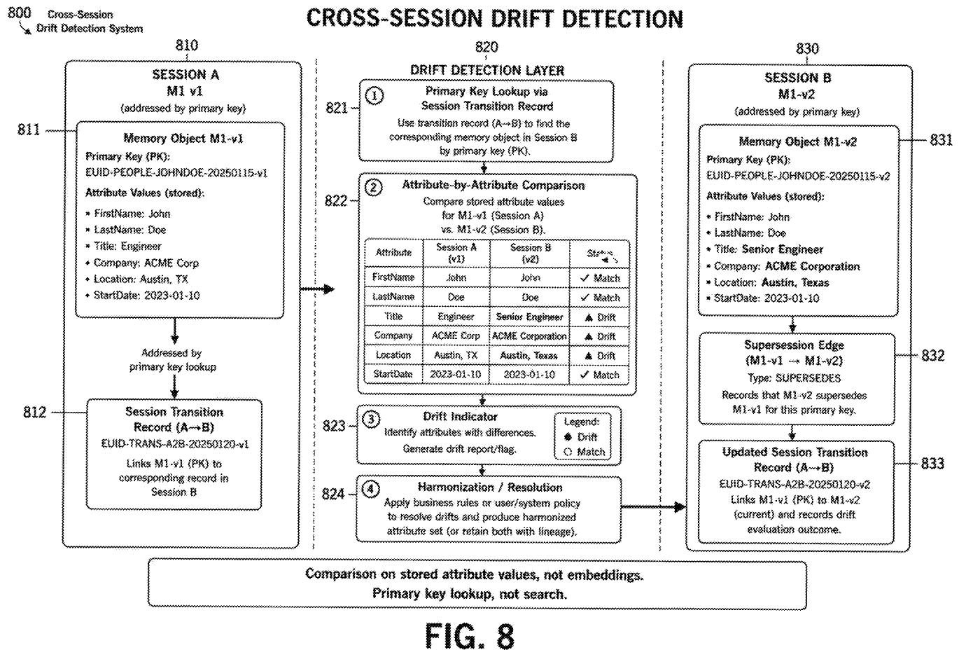

In some embodiments illustrated in FIG. 8 (800), the processing engine monitors contextual consistency across interaction sessions by evaluating contextual metadata of memory objects activated in a current session against the contextual metadata stored in corresponding memory objects from prior sessions, accessed through the session transition protocol described in § 7.9. FIG. 8 (800) illustrates this mechanism as a three-column diagram comprising: a Session A column (810) containing Memory Object M1-v1 (811) and Session Transition Record A→B (812); a central Drift Detection Layer (820) implementing primary key lookup via session transition record (821), attribute-by-attribute comparison (822), drift indicator generation (823), and harmonization/resolution (824); and a Session B column (830) containing Memory Object M1-v2 (831), Supersession Edge M1-v1→M1-v2 (832), and Updated Session Transition Record A→B (833). Contextual consistency evaluation is performed through address-based identifier lookup and relational reference traversal—the processing engine directly addresses prior-session memory objects by their structured identifiers, retrieved through primary key lookup via the session transition records (812, 821), and retrieves their stored contextual metadata without search across the stored memory object population. The comparison is performed between addressed memory objects identified through primary key lookup and not through similarity-resolved retrieval; the comparison is performed on stored attribute values of the corresponding memory objects rather than on derived embedding representations; the comparison does not constitute a similarity search; the comparison does not invoke vector embedding of the contextual input or of the stored memory object representations; and the comparison does not produce a ranking of candidate memory objects.

A contextual inconsistency—a drift condition—is detected when the contextual metadata of a currently active memory object diverges from the contextual metadata stored in the corresponding prior-session memory object beyond a configured consistency threshold. The configured consistency threshold is a pre-defined activation condition: a system parameter specifying the maximum permitted divergence between current and prior contextual metadata values before a drift condition is registered. Divergence is computed on specific stored attribute values of the corresponding memory objects, not on derived embedding representations of the contextual input or of the stored memory object representations.

Upon detecting a drift condition, the processing engine generates a drift indicator (823) associated with the affected memory object and triggers a harmonization operation (824). The harmonization operation (824) comprises: (i) generating a versioned successor memory object (831) encoding the updated contextual state, wherein the successor memory object is assigned a structured identifier in which the VERSION field is incremented to distinguish the successor from the prior version; (ii) creating a typed directed supersession edge (832) connecting the prior memory object (811) to the successor memory object (831) within the relational data structure; and (iii) updating session transition records (833) within the relational data structure to reference the harmonized successor memory object (831) as the current contextual state of the affected entity.

The prior memory object is preserved within the memory object store as a historical record node, remaining traversable through its structured identifier. The processing engine traverses typed directed supersession edges from historical nodes to current nodes through address-based identifier matching, enabling reconstruction of both the current contextual state and the historical arc of contextual evolution from the relational data structure alone—without search, ranking, similarity evaluation, embedding-based retrieval, keyword-frequency scoring, or learned text-to-identifier mapping at any stage of the drift detection or harmonization process. The claimed drift detection mechanism is structurally distinct from prior art bitemporal data models, knowledge graph versioning frameworks, and ontology evolution systems: those prior art systems address the storage and querying of versioned data through delta-based, snapshot-based, or bitemporal mechanisms, but they do not couple version management with address-based contextual consistency evaluation across structured session transition records, and they typically rely on similarity-based retrieval or time-range queries to surface relevant historical states rather than on direct primary key lookup.

The configured consistency threshold is a pre-defined system parameter specifying the maximum permitted divergence between the stored attribute values of a currently active memory object and the stored attribute values of the corresponding prior-session memory object before a drift condition is registered. The configured consistency threshold is set at deployment time or at session-open time, prior to any consistency evaluation in the current interaction session. In some embodiments, the configured consistency threshold is category-specific: memory objects whose structured identifier encodes CATEGORY=PEOPLE may have a different configured consistency threshold than memory objects encoding CATEGORY=CONCEPTS or CATEGORY=ARTIFACTS, enabling the system to apply category-appropriate drift sensitivity. Category-specific threshold configuration is a system parameter set independently for each category from the defined set.

Attribute comparison for drift detection is performed on typed stored attribute values. For categorical attributes—such as NAME, STATUS, or CATEGORY fields—the comparison is an equality predicate: a drift contribution is registered when the current categorical value of the attribute is not equal to the prior categorical value stored in the corresponding prior-session memory object. For numeric attributes—such as DATE fields represented as ordinal values—the comparison is a magnitude divergence: a drift contribution is registered when the absolute difference between the current numeric value and the prior numeric value exceeds the configured numeric consistency threshold. For collection attributes—such as ACTIVE MEMORY OBJECTS fields encoding comma-separated sets of structured identifiers—the comparison is a symmetric set-difference measure: a drift contribution is registered when the count of identifiers present in one set but not the other exceeds a configured cardinality consistency threshold. Weighted combinations of per-attribute contributions may be used to produce an aggregate drift measure for the memory object as a whole. All comparisons are performed on the stored attribute values of memory objects identified through direct primary key lookup; no comparison is performed on vector embedding representations of the contextual input or of the stored memory object representations.

To illustrate with a concrete embodiment: the relational data structure contains a PEOPLE memory object for an individual named Jessica—address EUID-PEOPLE-JESSICA-v1—whose v1 card encodes relational metadata attributes reflecting a warm, close relationship at the time the card was written. Following a significant disagreement, the current session's contextual state for Jessica diverges from the v1 stored attributes. At the next session initiation, the drift detection module retrieves EUID-PEOPLE-JESSICA-v1 through direct primary key lookup via the session transition record—not through any search or similarity computation—and retrieves the stored contextual metadata. The module compares current session metadata against v1 stored values using the typed comparison predicates: the STATUS attribute (categorical) has changed from CLOSE to COMPLICATED; the comparison registers a categorical mismatch. The aggregate drift measure exceeds the configured consistency threshold for CATEGORY=PEOPLE. The harmonization operation generates EUID-PEOPLE-JESSICA-v2, encoding the updated relational state; creates a typed directed supersession edge from EUID-PEOPLE-JESSICA-v1 to EUID-PEOPLE-JESSICA-v2 within the relational data structure; and updates the session transition record to reference EUID-PEOPLE-JESSICA-v2 as the current state of that memory object. EUID-PEOPLE-JESSICA-v1 remains in the relational data structure as a historical record node, traversable through its structured identifier and through the supersession edge. The v1 and v2 cards together form a version arc: who Jessica was before the disagreement, what changed, and where things stand now—structurally encoded, directly addressable, traversable without search.

### 7.12—7.16 Operational Embodiments

Operational embodiments concerning manual, semi-automated, and automated modes of operation; user interaction interfaces; categorical lexicon extensibility; embodiment in distributed and stateless computing environments; and embodiment in artificial intelligence systems including natural language processing systems, are as described in the parent application and are incorporated herein by reference. The structural architecture described in §§ 7.1 through 7.11 is preserved across all operational embodiments.

What is claimed is:

1. A computer-implemented system for reconstructing contextual state across interaction sessions, comprising:
(a) an input interface configured to receive contextual input;
(b) a structured identifier module implemented on one or more processors and configured to generate, for the contextual input, a structured identifier organized in accordance with a schema comprising a fixed system-level prefix followed by a category field, a semantic tag field, a temporal field, and a version field, wherein the structured identifier is generated by direct extraction of attribute values from the contextual input in accordance with the schema, and is not generated by trained mapping or classification of the contextual input to a label set of pre-existing identifiers stored in the relational data structure, and wherein the structured identifier serves as a primary key for direct address-based memory object lookup in the relational data structure without similarity search, ranking, vector embedding-based retrieval, keyword-frequency scoring, or learned text-to-identifier mapping across the stored memory object population;
(c) a memory storage system configured to store a plurality of memory objects on a non-transitory computer-readable medium, each memory object comprising a respective structured identifier, contextual metadata comprising data attributes directly associated with the memory object, and one or more relational references each containing the structured identifier of a referenced memory object;
(d) a relational data structure implemented as a directed graph configured to maintain the relational references among the plurality of memory objects as typed directed edges encoding at least one of temporal relationships, semantic relationships, or contextual associations; and
(e) a processing engine implemented on one or more processors and configured to: identify candidate memory objects through direct address-based lookup using the structured identifier as a primary key in the relational data structure without search or similarity evaluation; apply one or more pre-defined activation conditions to the relational references, wherein a pre-defined activation condition comprises a traversal rule specifying that a candidate memory object is activated when a relational reference stored within a currently activated memory object contains the structured identifier of the candidate memory object; iteratively activate additional memory objects through traversal of relational references until no additional memory objects satisfy the pre-defined activation conditions or a defined traversal depth is reached; and construct a contextual state representation by reconstructing from the activated set: (i) an aggregation of contextual metadata from the activated memory objects; and (ii) relational context comprising information derived from the types, directions, and attributes of the directed edges connecting the activated memory objects;
wherein:
identification and activation are performed without search, ranking, similarity scoring, vector embedding-based retrieval, keyword-frequency scoring, learned text-to-identifier mapping, or probabilistic similarity evaluation at any stage of the identification or activation process; no embedding-based representation is computed for the contextual input and no vector similarity score is computed between the contextual input and any stored memory object representation; identical pre-defined activation conditions applied to an identical relational data structure state produce an identical set of activated memory objects; and the contextual state representation is a reconstructed artifact usable to influence subsequent processing of contextual input across interaction sessions independently of session-specific conversational memory storage.
INDEPENDENT CLAIM 2—SESSION TRANSITION PROTOCOL

2. A computer-implemented system for maintaining deterministic contextual continuity across interaction sessions through a session transition protocol, comprising:
(a) a memory storage system configured to store a plurality of memory objects on a non-transitory computer-readable medium, each memory object indexed by a structured identifier organized in accordance with a schema comprising a fixed system-level prefix and a category field, a semantic tag field, a temporal field, and a version field, the structured identifier serving as a primary key for direct address-based memory object lookup;
(b) a relational data structure implemented as a directed graph configured to maintain explicit typed directed relational references among the plurality of memory objects;
(c) a processing engine implemented on one or more processors and configured to: encode session boundaries within the relational data structure by generating, upon conclusion of each interaction session, an exit-stamp memory object comprising a structured identifier, contextual metadata encoding the session conclusion state including the structured identifiers of memory objects active at session conclusion, and one or more relational references to memory objects activated at session conclusion; encode the initiation of each subsequent interaction session by generating an entry-stamp memory object comprising a structured identifier, contextual metadata encoding the session initiation state, and a typed directed relational reference to the corresponding exit-stamp memory object, wherein the typed directed relational reference connecting the exit-stamp memory object to the entry-stamp memory object is stored within the relational data structure as a session transition record encoded as a typed directed edge addressable by structured identifier; upon initiation of a new interaction session, identify the entry-stamp memory object associated with the session solely through direct primary key matching of its structured identifier and not through similarity computation against any stored memory representation, activate the entry-stamp memory object, and propagate activation through its relational references to reconstruct prior session contextual state through deterministic address-based traversal of the relational data structure; and construct a contextual state representation from the activated set comprising aggregated contextual metadata and relational context derived from the typed directed edges connecting the activated memory objects;
wherein:
cross-session contextual continuity is achieved through traversal of session transition records encoded as typed directed edges within the relational data structure, without requiring prior session conversational content to be retained, reintroduced, or accessed; identification and activation at session initiation are performed without search, ranking, similarity scoring, vector embedding-based retrieval, keyword-frequency scoring, learned text-to-identifier mapping, or probabilistic similarity evaluation at any stage; and no embedding-based representation is computed for the contextual input of the new interaction session and no vector similarity score is computed between the contextual input and any stored memory object representation of any prior interaction session.
INDEPENDENT CLAIM 3—RESONANCE-BASED LOOP ACTIVATION WITH ANCHORING

3. A computer-implemented method for resonance-based loop activation and anchoring point creation within a relational data structure, the method being executed by one or more processors, the method comprising:
(a) receiving contextual input and generating a structured identifier organized in accordance with a schema comprising a fixed system-level prefix followed by a category field, a semantic tag field, a temporal field, and a version field, wherein the structured identifier is generated by direct extraction of attribute values from the contextual input in accordance with the schema and is not generated by trained mapping or classification of the contextual input to a label set of pre-existing identifiers, and wherein the structured identifier serves as a primary key for direct address-based memory object lookup;
(b) identifying, through direct address-based lookup using the structured identifier as a primary key, one or more candidate memory objects within a relational data structure implemented as a directed graph, each candidate memory object comprising a respective structured identifier, contextual metadata, and one or more relational references each containing the structured identifier of a referenced memory object and an associative property value encoded as a static attribute of the relational reference set as a system parameter at the time the relational reference is created or updated;
(c) applying a threshold-based association criterion configured as a pre-defined system parameter to the relational references among candidate memory objects, wherein the threshold-based association criterion specifies a minimum associative property value that a relational reference must encode for activation to propagate along that relational reference, and wherein evaluation of the threshold-based association criterion operates on the static attribute values of the relational references and does not require, and does not invoke, computation of similarity metrics between the contextual input and any stored memory object representation, vector embedding of the contextual input, keyword-frequency scoring of the contextual input against any stored memory object representation, or ranking of candidate memory objects against the contextual input;
(d) initiating a loop activation sequence by activating memory objects whose relational references satisfy the threshold-based association criterion through address-based identifier matching, and iteratively activating additional connected memory objects through continued traversal of relational references satisfying the threshold-based association criterion, until no additional relational references in the activated subgraph satisfy the threshold-based association criterion or a saturation condition is reached;
(e) upon reaching the saturation condition, generating an anchoring point memory object comprising a structured identifier organized in accordance with the schema, contextual metadata encoding the saturation state of the loop activation sequence, and typed directed edges connecting the anchoring point memory object to each memory object activated during the loop activation sequence, and storing the anchoring point memory object within the relational data structure as an addressable node; and
(f) constructing a contextual state representation from the activated set comprising: (i) an aggregation of contextual metadata from the activated memory objects; and (ii) relational context derived from the types, directions, and attributes of the relational references connecting the activated memory objects;
wherein activation in steps (d) and (e) is performed without search, ranking, similarity scoring, vector embedding-based retrieval, keyword-frequency scoring, learned text-to-identifier mapping, or probabilistic similarity evaluation at any stage; the threshold-based association criterion operates on associative property values stored as static attributes of relational references prior to the activation operation and not derived at activation time from any input-conditioned similarity computation; and the anchoring point memory object is addressable by its structured identifier for subsequent deterministic activation across interaction sessions.
INDEPENDENT CLAIM 4—CROSS-SESSION DRIFT DETECTION AND MITIGATION

4. A computer-implemented method for detecting and mitigating cross-session contextual drift within a relational memory system, the method being executed by one or more processors, the method comprising:
(a) maintaining a plurality of memory objects stored on a non-transitory computer-readable medium within a relational data structure implemented as a directed graph, each memory object indexed by a structured identifier organized in accordance with a schema comprising a fixed system-level prefix and a category field, a semantic tag field, a temporal field, and a version field, the structured identifier serving as a primary key for direct address-based memory object lookup;
(b) maintaining session transition records within the relational data structure, each session transition record comprising a typed directed edge connecting an exit-stamp memory object associated with a concluded interaction session to an entry-stamp memory object associated with a subsequent interaction session, enabling traversal of session boundaries through address-based identifier matching;
(c) upon initiation of a current interaction session, identifying memory objects from prior interaction sessions through direct primary key lookup via the session transition records, and retrieving their stored contextual metadata through address-based traversal of the relational data structure without search;
(d) evaluating contextual consistency by comparing stored attribute values of contextual metadata of memory objects active in the current interaction session against stored attribute values of contextual metadata of corresponding memory objects from prior interaction sessions identified through direct primary key lookup, and detecting a drift condition when one or more compared attribute values diverge beyond a configured consistency threshold configured as a pre-defined system parameter, wherein the comparison is performed between memory objects retrieved through direct primary key lookup and is not performed through search across the stored memory object population, the comparison is performed on stored attribute values of the corresponding memory objects and is not performed on derived embedding representations of the contextual input or of the stored memory object representations, and the comparison does not invoke vector embedding of the contextual input, keyword-frequency scoring, or ranking of candidate memory objects against the contextual input;
(e) upon detecting a drift condition, generating a versioned successor memory object comprising a structured identifier in which the version field is modified to distinguish the successor from the prior memory object, creating a typed directed supersession edge within the relational data structure connecting the prior memory object to the successor memory object, and updating session transition records within the relational data structure to reference the successor memory object; and
(f) preserving the prior memory object within the relational data structure as a historical record node addressable by its structured identifier, and traversing typed directed supersession edges from historical nodes to current nodes through address-based identifier matching to enable reconstruction of both the current contextual state and the historical arc of contextual evolution;
wherein drift detection in step (d), harmonization in step (e), and successor traversal in step (f) are performed without search, ranking, similarity scoring, vector embedding-based retrieval, keyword-frequency scoring, learned text-to-identifier mapping, or probabilistic similarity evaluation at any stage.
DEPENDENT CLAIMS

5. The system of claim 1, wherein the fixed system-level prefix is the literal string EUID, and the structured identifier is organized as [EUID]-[CATEGORY]-[TAG]-[DATE]-[VERSION], wherein CATEGORY is drawn from a defined set of categories including at least people, events, locations, concepts, and artifacts, and TAG is drawn from a defined lexicon of semantic descriptors associated with each category.

6. The system of claim 1, wherein the defined set of categories is extensible to include additional categories comprising at least one of: crystallizations of conceptual insights arising from interaction sessions; protocols governing system interaction parameters; session transition records documenting entry and exit boundaries between interaction sessions; directional associative links between memory structures; or emotional state representations—each additional category being drawn from a defined set and associated with a defined lexicon of semantic descriptors.

7. The system of claim 1, wherein the typed directed edges encode temporal relationships, semantic relationships, and contextual associations among memory objects, and wherein each typed directed edge stores the structured identifier of the source node, the structured identifier of the target node, and the relationship type.

8. The system of claim 1, wherein the processing engine activates memory objects when the pre-defined activation conditions are satisfied independently of the temporal order in which the memory objects were stored in the memory storage system, and the directed graph supports non-linear traversal across temporal and semantic dimensions.

9. The system of claim 1, wherein the contextual input comprises at least one of textual input, symbolic input, event-based input, or audio input.

10. The system of claim 1, wherein the contextual state representation comprises a first component comprising aggregated contextual metadata from the activated memory objects derived from node attributes of the activated nodes, and a second component comprising relational context derived from edge attributes of the directed edges connecting the activated nodes, wherein the first and second components are structurally non-redundant and together constitute a reconstruction that neither component could produce in isolation.

11. The system of claim 1, wherein the pre-defined activation conditions include a threshold-based association criterion specifying that activation propagates along a relational reference when an associative property value encoded as a static attribute of that relational reference satisfies a defined threshold value configured as a system parameter prior to the activation operation, without computing similarity metrics between the contextual input and stored memory object representations and without computing vector embeddings of the contextual input.

12. The system of claim 1, wherein at least one memory object corresponds to an event-based anchor memory object associated with a contextual input designated as warranting anchor status based on explicit user designation or automated significance criteria including event type, temporal interval, or configured significance thresholds, serving as a reference point node for subsequent deterministic address-based activation across interaction sessions.

13. The system of claim 1, wherein the system operates in at least one of a manual mode, a semi-automated mode, or an automated mode, and transitions between modes depending on implementation requirements or system configuration.

14. The system of claim 1, wherein the contextual state representation is a reconstructed artifact derived from activated memory objects and their directed relational references, distinct from stored session-specific conversational content and from the memory objects themselves.

15. The system of claim 1, wherein upon completion of iterative activation the processing engine records a termination state in the memory storage system indicating the activation process is complete and identifying the final set of activated memory objects, the termination state being usable by downstream processing components to confirm the contextual state representation reflects the complete activation result.

16. The system of claim 2, wherein the exit-stamp memory object further comprises a carryover summary field encoding open contextual threads, pending action items, and session state information designated for reactivation in the subsequent interaction session, stored as contextual metadata within the exit-stamp memory object and accessible through address-based identifier lookup without requiring stored session conversational content.

17. The system of claim 2, wherein session transition records within the relational data structure form a temporal chain of typed directed edges connecting sequential session boundaries, enabling multi-session traversal through address-based identifier matching from any entry-stamp memory object through its associated exit-stamp memory object to the entry-stamp memory object of any prior session in the chain.

18. The system of claim 2, wherein contextual continuity is maintained by addressing memory objects created in prior interaction sessions through their structured identifiers within the relational data structure, without requiring prior session conversational content to be retained or reintroduced and without computing similarity scores between the contextual input of the current interaction session and stored memory representations of any prior interaction session.

19. The method of claim 3, wherein the threshold-based association criterion is derived from associative property values encoded as static attributes of typed directed edges within the relational data structure at the time relational references are created or updated, and wherein the configured minimum associative property value is a system parameter set prior to the activation operation and applied consistently across all loop activation cycles.

20. The method of claim 3, wherein the anchoring point memory object generated upon loop saturation is assigned a structured identifier in accordance with the schema and stored as a first-class node within the relational data structure, enabling the anchoring point memory object to serve as an activation seed for subsequent deterministic loop activation sequences initiated from the anchoring point in future interaction sessions.

21. The method of claim 3, further comprising encoding a lexicon of canonical associative property values as static attributes of relational references within the relational data structure, wherein the lexicon defines associative property values for at least one of: emotional state associations; ritual event associations; temporal proximity associations; or symbolic significance associations—the associative property values serving as the static attributes evaluated by the threshold-based association criterion during loop activation without requiring similarity computation between contextual input and stored memory representations.

22. The method of claim 3, wherein loop saturation is determined by a saturation condition comprising at least one of: no additional relational references in the activated subgraph satisfy the threshold-based association criterion; a defined maximum loop depth specifying a maximum number of iterative activation steps is reached; or a defined saturation threshold specifying a maximum proportion of the relational data structure traversable by the loop activation sequence is reached.

23. The method of claim 4, wherein the configured consistency threshold is specific to the CATEGORY field of the structured identifier of the affected memory object, enabling category-specific drift sensitivity parameters to be applied to different classes of memory objects within the relational data structure.

24. The method of claim 4, wherein the harmonization operation further comprises generating a drift indicator memory object comprising a structured identifier organized in accordance with the schema, contextual metadata encoding the nature and magnitude of the detected drift condition, and typed directed edges connecting the drift indicator to the prior memory object and to the versioned successor memory object, storing the drift indicator memory object within the relational data structure as an addressable node for subsequent deterministic activation and drift history traversal.

25. The method of claim 4, wherein versioned successor memory objects generated through harmonization operations form a version chain within the relational data structure comprising a sequence of typed directed supersession edges connecting prior memory objects to successor memory objects in temporal order, enabling reconstruction of the complete contextual evolution history of any memory object through address-based traversal of the version chain without search.

26. The system of claim 1, wherein the processing engine generates additional memory objects based on the contextual state representation and incorporates them into the relational data structure as new nodes with typed directed edges, wherein the structured identifiers of the new memory objects are generated in accordance with the schema by direct attribute extraction from the contextual state representation and not by trained mapping or classification.

27. The system of claim 1, wherein identification of candidate memory objects is performed through direct address-based lookup using the structured identifier as a primary key, without probabilistic similarity scoring and without vector embedding-based retrieval, and wherein the processing engine implements address-based activation as a graph traversal algorithm comprising: a seed identification step performing direct primary key lookup without similarity search; an initial activation step activating identified seed nodes; a traversal step evaluating outbound typed directed edges by applying pre-defined activation conditions; and an iterative expansion step repeating traversal until a termination condition is reached.

28. The system of claim 2, wherein the system further comprises a drift detection module configured to compare stored attribute values of memory objects active in a current interaction session against stored attribute values of corresponding memory objects from prior interaction sessions identified through direct primary key lookup via the session transition records, detect a drift condition when compared attribute values diverge beyond a configured consistency threshold, and upon detecting a drift condition generate a versioned successor memory object connected to the prior memory object by a typed directed supersession edge within the relational data structure, wherein the session transition records provide the address-based access to prior-session memory objects required for contextual consistency evaluation without search, ranking, similarity scoring, or vector embedding-based retrieval at any stage.

29. The method of claim 3, wherein the loop activation sequence is seeded by an entry-stamp memory object identified through direct primary key matching of its structured identifier within the relational data structure, the entry-stamp memory object being connected by a typed directed edge to a corresponding exit-stamp memory object encoding the session conclusion state of a prior interaction session, enabling resonance-based loop activation to propagate from a session boundary anchor point through the relational data structure across interaction session boundaries through address-based identifier matching without search, ranking, or similarity evaluation.

30. A non-transitory computer-readable medium storing instructions that, when executed by one or more processors, cause the one or more processors to perform operations comprising: generating a structured identifier for contextual input by direct extraction of attribute values in accordance with a schema comprising a fixed system-level prefix followed by a category field, a semantic tag field, a temporal field, and a version field, wherein the structured identifier serves as a primary key for direct address-based memory object lookup; identifying candidate memory objects through direct address-based lookup using the structured identifier as a primary key within a relational data structure implemented as a directed graph; applying pre-defined activation conditions comprising a traversal rule specifying that a candidate memory object is activated when a relational reference stored within a currently activated memory object contains the structured identifier of the candidate memory object; iteratively activating additional memory objects through traversal of relational references until no additional memory objects satisfy the pre-defined activation conditions or a defined traversal depth is reached; and constructing a contextual state representation comprising an aggregation of contextual metadata from the activated memory objects and relational context derived from the types, directions, and attributes of the directed edges connecting the activated memory objects; wherein all operations are performed without search, ranking, similarity scoring, vector embedding-based retrieval, keyword-frequency scoring, learned text-to-identifier mapping, or probabilistic similarity evaluation at any stage.
